(19) United States
(12) Patent Application Publication
(10) Pub. No.: US 2026/0039423 A1
(43) Pub. Date: Feb. 5, 2026

(54) System Information Modification Indication for Cross-Carrier SIB Transmission

(71) Applicant: Apple Inc., Cupertino, CA (US)

(72) Inventors: Sigen YE, San Diego, CA (US); Chunhai YAO, Beijing (CN); Dawei ZHANG, Saratoga, CA (US); Hong HE, San Jose, CA (US); Oghenekome OTERI, San Diego, CA (US); Peng CHENG, Beijing (CN); Seyed Ali Akbar FAKOORIAN, San Diego, CA (US); Wei ZENG, Saratoga, CA (US)

(21) Appl. No.: 19/103,275

(22) PCT Filed: Aug. 11, 2023
(86) PCT No.: PCT/US2023/030059

§ 371 Date: Feb. 12, 2025

Related U.S. Application Data
(60) Provisional application No. 63/371,241, filed on Aug. 12, 2022.

(51) Int. Cl. H04L 5/00; H04W 8/00; H04W 68/02; H04W 72/231; H04W 76/28

(52) U.S. Cl. CPC H04L 5/0032; H04W 8/005; H04W 68/02; H04W 72/231; H04W 76/28

(57) ABSTRACT

A user equipment (UE) configured to decode, based on signaling received from a base station, a system information modification indication, monitor a first carrier for one or more types of system information blocks (SIBs) of a second carrier in response to the system information modification indication, wherein the second carrier is configured with cross-carrier SIB transmission on the first carrier for the one or more types of SIBs and decode, based on signaling received from the base station a SIB for the second carrier on the first carrier.

### PRIORITY/INCORPORATION BY REFERENCE

This application claims priority to U.S. Provisional Application Ser. No. 63/371,241 filed on Aug. 12, 2022, and entitled “System Information Modification Indication for Cross-Carrier SIB Transmission,” the entirety of which is incorporated herein by reference.

### BACKGROUND

In a multi-carrier deployment scenario, a base station may offload certain types of common signaling for one carrier to another carrier for network power saving. For instance, the base station may utilize cross-carrier system information block (SIB) transmissions where one or more SIBs for a first carrier are transmitted on a second different carrier. This may create time domain energy saving opportunities on the first carrier.

For any of a variety of different reasons, a network may be triggered to update certain types of system information. The updated system information may be provided to the UE in one or more SIBs. It has been identified that there is a need for system modification indication techniques configured to support the implementation of cross-carrier SIB transmission.

### SUMMARY

Some exemplary embodiments are related to an apparatus of a user equipment (UE), the apparatus having processing circuitry configured to decode, based on signaling received from a base station, a system information modification indication, monitor a first carrier for one or more types of system information blocks (SIBs) of a second carrier in response to the system information modification indication, wherein the second carrier is configured with cross-carrier SIB transmission on the first carrier for the one or more types of SIBs and decode, based on signaling received from the base station a SIB for the second carrier on the first carrier.

Other exemplary embodiments are related to a processor configured to decode, based on signaling received from a base station, a system information modification indication, monitor a first carrier for one or more types of system information blocks (SIBs) of a second carrier in response to the system information modification indication, wherein the second carrier is configured with cross-carrier SIB transmission on the first carrier for the one or more types of SIBs and decode, based on signaling received from the base station a SIB for the second carrier on the first carrier.

Still further exemplary embodiments are related to an apparatus of a base station, the apparatus having processing circuitry configured to configure transceiver circuitry to transmit a system information modification indication to a user equipment (UE), wherein the base station deploys at least a first carrier and a second carrier and wherein the second carrier is configured with cross-carrier system information block (SIB) transmission on the first carrier for one or more types of SIBs and configure transceiver circuitry to transmit a SIB for the second carrier on the first carrier.

Additional exemplary embodiments are related to a processor configured to configure transceiver circuitry to transmit a system information modification indication to a user equipment (UE), wherein the base station deploys at least a first carrier and a second carrier and wherein the second carrier is configured with cross-carrier system information block (SIB) transmission on the first carrier for one or more types of SIBs and configure transceiver circuitry to transmit a SIB for the second carrier on the first carrier.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4a shows an exemplary scenario for cross-carrier system information broadcast (SIB) transmission according to various exemplary embodiments.

FIG. 4b shows an exemplary scenario for cross-carrier SIB transmission according to various exemplary embodiments.

FIG. 5 shows a method for system information modification according to various exemplary embodiments.

FIG. 6 shows a signaling diagram for system information modification indication for a SIB-less carrier transmitted on the SIB-less carrier according to various exemplary embodiments.

FIG. 7 shows a signaling diagram for system information modification indication for a SIB-less carrier being transmitted on another carrier via paging DCI according to various exemplary embodiments.

### DETAILED DESCRIPTION

The exemplary embodiments may be further understood with reference to the following description and the related appended drawings, wherein like elements are provided with the same reference numerals. The exemplary embodiments relate to cross-carrier system information block (SIB) transmissions. As will be explained in more detail below, the exemplary embodiments introduce techniques for system information modification indications to support the implementation of cross-carrier SIB transmissions.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The exemplary embodiments are described with regard to a multi-carrier deployment scenario comprising at least a first carrier and a second carrier. To differentiate between the two carriers, reference is made to “carrier 1” and “carrier 2.” Those skilled in the art will understand that a carrier generally refer to one or more frequency bands operated by a cell of a gNB. Throughout this description, any references to either carrier 1 or carrier 2 possessing certain characteristics are provided as an example. The carrier 1 and carrier 2 classification are not intended to limit the exemplary embodiments in any way and are only intended to differentiate between carriers in a multi-carrier deployment scenario. In addition, the examples provided below describe carrier 1 and carrier 2 as being operated by different cells of the same gNB. However, the exemplary are not limited to this arrangement and may be utilized by a multi-carrier system comprising any number of carriers operated by any number of base stations.

Offloading common signaling of carrier 2 to carrier 1 may provide the gNB operating a cell on carrier 2 with time domain energy saving opportunities. For instance, in a multi-carrier deployment scenario configured to support cross-carrier SIB transmission, the SIBs for carrier 1 and one or more types of SIBs for carrier 2 may both be transmitted on carrier 1. That is, system information corresponding to one carrier may be transmitted on a different carrier. While cross-carrier SIB transmission may provide network power saving benefits, the manner in which cross-carrier SIB transmission is triggered and performed is beyond the scope of the exemplary embodiments. The exemplary embodiments may be applied to any multi-carrier deployment scenario configured to support cross-carrier SIB transmission for any appropriate reason.

The exemplary embodiments introduce techniques related to system information modification to support the implementation of cross-carrier SIB transmission. The exemplary techniques may be used independently from one another, in conjunction with other currently implemented mechanisms for system information modification, in conjunction with future implementations of mechanisms system information modification and independently from other mechanisms for system information modification.

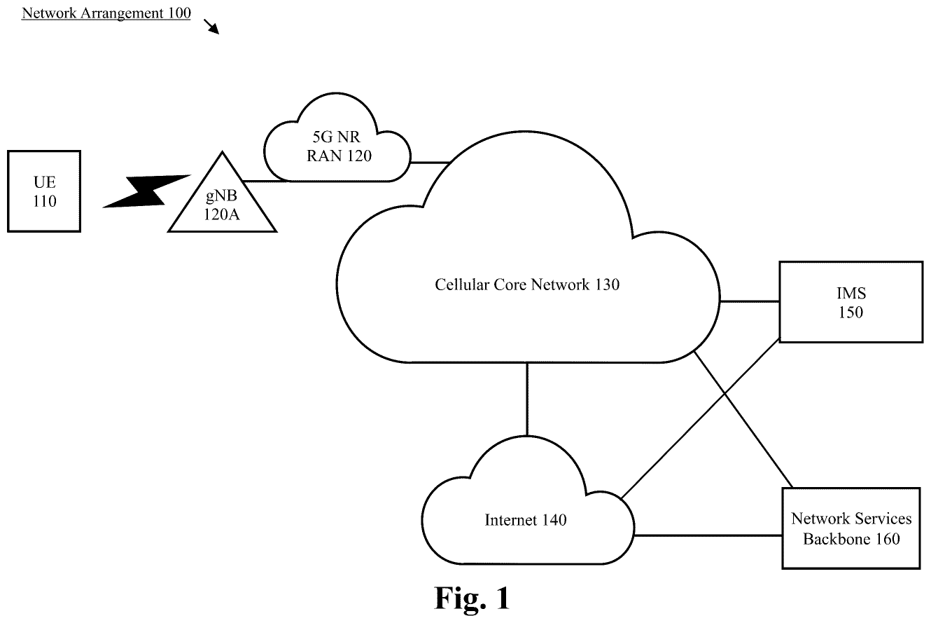

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., a 6G RAN, a 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

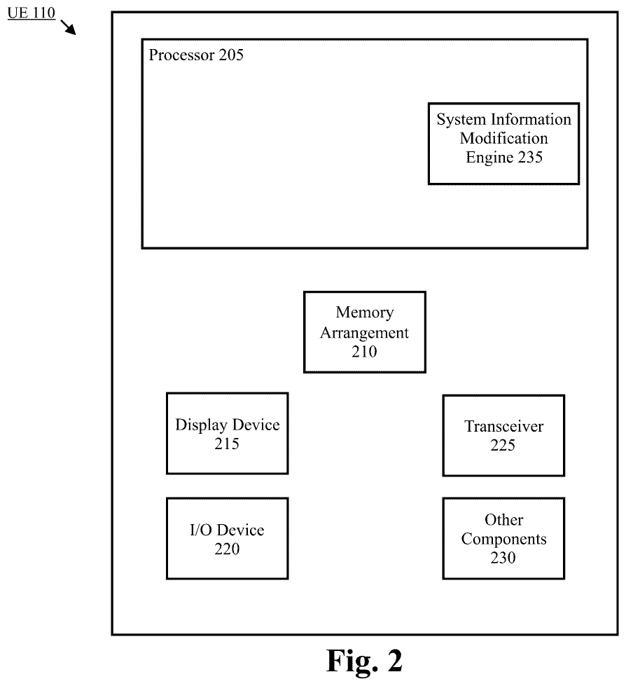

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a system information modification engine 235. The system information modification engine 235 may perform various operations related to the exemplary techniques introduced herein such as, but not limited to, receiving a system information modification indication and receiving updated system information via cross-carrier SIB transmission.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

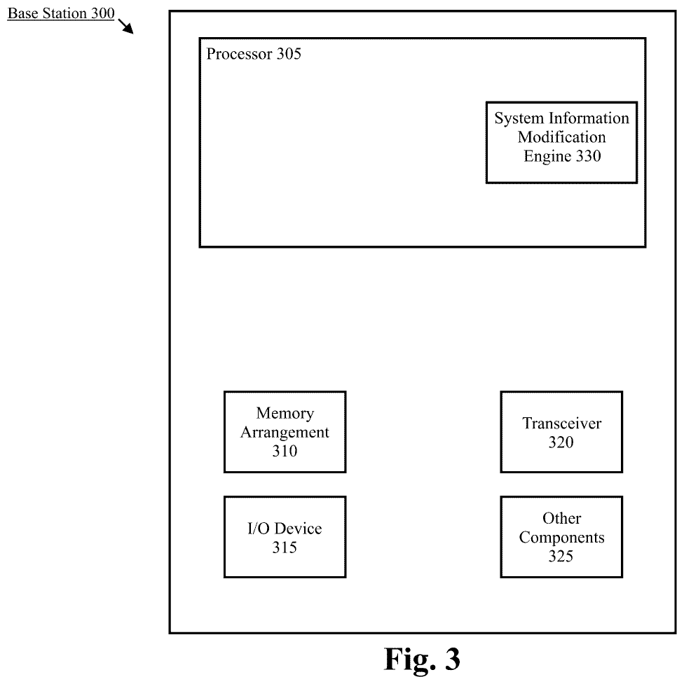

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a system information modification engine 330. The system information modification engine 330 may perform various operations related to the exemplary techniques introduced herein such as, but not limited to, transmitting a system information modification indication and transmitting updated system information via cross-carrier SIB transmission.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

The exemplary embodiments are described with regard to a multi-carrier deployment scenario configured to support cross-carrier SIB transmission. In the examples provided below, the transmission of one or more types of SIBs for carrier 2 are offloaded to carrier 1. Thus, the SIBs for carrier 1 and one or more SIBs for carrier 2 may both be transmitted on carrier 1. In these examples, carrier 2 may be referred to as a “SIB-less carrier.” The term “SIB-less carrier” may refer to a carrier that is configured without SIB transmission (for at least a subset of SIBs). The cross-carrier SIB transmission functionality may be dynamically activated and deactivated. Accordingly, a carrier may be a SIB-less carrier during one time interval and transmit its own SIBs during a second different time interval. However, “SIB-less carrier” does not necessarily mean that the transmission of every type of SIB is offloaded to another carrier. Instead, the term “SIB-less carrier” relates to a carrier that is configured without SIB transmission for one or more types of SIBs because the one or more types of SIBs for the carrier are offloaded to at least one other carrier.

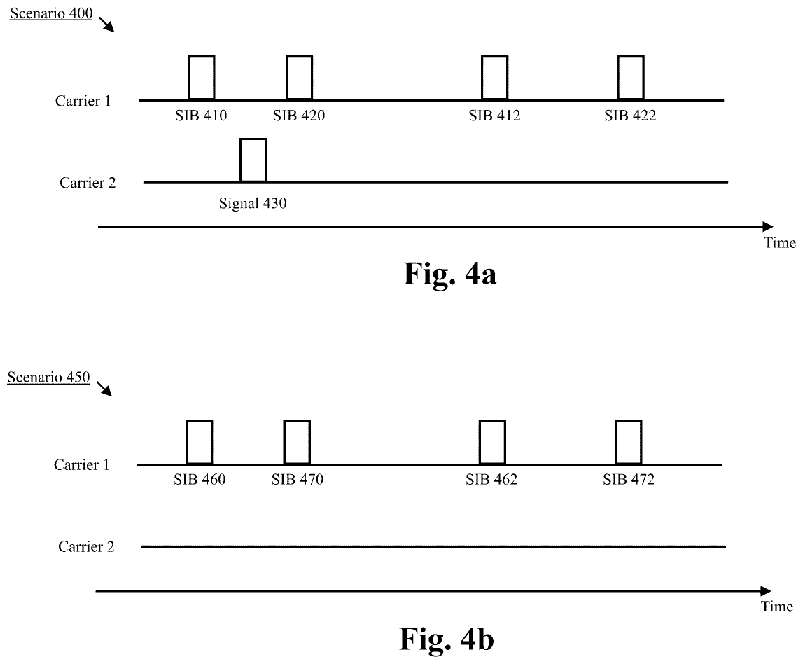

FIG. 4a shows an exemplary scenario 400 for cross-carrier SIB transmission according to various exemplary embodiments. The scenario 400 includes a time interval during which carrier 1 is configured to transmit SIBs 410, 412 for carrier 1 and SIBs 420, 422 for carrier 2 (e.g., cross-carrier SIB transmission).

According to some aspects, the SIB-less carrier (e.g., carrier 2) may still be configured to transmit different types of signals. For example, broadcast signals such as, but not limited to, synchronization signal block (SSB), primary synchronization signal (PSS), secondary synchronization signal (SSS), certain types of system information (e.g., SIBs), discovery reference signal (DRS) and tracking reference signal (TRS) may be transmitted on the SIB-less carrier. It may be beneficial for network power saving purposes to limit the number and/or types of signals transmitted on the SIB-less carrier because decreasing the number of signals transmitted by the SIB-less carrier may increase the number of time domain energy saving opportunities. However, except for the one or more types of SIBs being offloaded, the SIB-less carrier is not required to be restricted from transmitting any particular type of signal.

In the scenario 400, carrier 2 is still configured to transmit certain types of signals, an example of which is depicted in scenario 400 as signal 430. In this example, signal 430 may represent an SSB, a discovery signal, a synchronization signal, a reference signal and/or limited system information. Accordingly, while carrier 2 is configured without the transmission of one or more types of SIBs, UEs may still be able to discover and measure carrier 2 and/or perform time and frequency tracking using at least in part, signal 430. However, this example is merely provided for illustrative purposes. As indicated above, a SIB-less carrier is not required to be restricted from transmitting any particular type of signal except for the one or more types of SIBs offloaded to another carrier.

To provide an example from the perspective of the UE 110 within the context of the scenario 400, the UE 110 may monitor carrier 2 for certain types of broadcast signals, limited system information and/or paging. The UE 110 may then switch to monitoring carrier 1 to receive the SIB 420 and/or SIB 422 for carrier 2. In some embodiments, the UE 110 may be configured to blindly search carrier 1 for the SIBs of carrier 2 based on information broadcast on carrier 1 or provided to the UE 110 in any other appropriate manner. In other embodiments, the UE 110 may receive system information on carrier 2 (e.g., signal 430) comprising information that the UE 110 may utilize to receive the SIBs for carrier 2 on carrier 1. For example, signal 430 may comprise limited system information including, but not limited to, a physical cell ID for carrier 1, a carrier frequency of carrier 1, a search space set configuration for carrier 1 where the UE 110 may monitor for SIBs for carrier 2, any combination thereof and/or any other appropriate type of information. In further examples, this type of limited system information may be transmitted by carrier 1 and received by the UE 110.

FIG. 4b shows an exemplary scenario 450 for cross-carrier SIB transmission according to various exemplary embodiments. Like the scenario 400, the scenario 450 includes a time interval during which carrier 1 is configured to transmit SIBs 460, 462 for carrier 1 and SIBs 470, 472 for carrier 2 (e.g., cross-carrier SIB transmission).

According to some aspects, the network may not need to transmit any other types of signals on the SIB-less carrier. For example, a contiguous carrier may be used which enable the UE 110 to obtain synchronization and measurement from one carrier and use it on another carrier. Accordingly, in contrast to scenario 400, there are no other signals (e.g., SSB, SIB1, limited system information, etc.) transmitted on carrier 2 in the scenario 450.

To provide an example from the perspective of the UE 110 within the context of the scenario 450, the UE 110 may camp on a cell operating on carrier 1 and follow legacy behavior, e.g., receive SIBs for carrier 1 on carrier 1, receive paging on carrier 1 and perform initial access on carrier 1. In another example, the UE 110 may still monitor for paging on carrier 1. However, when the UE 110 gets paged on carrier 1, the UE 110 may initiate the initial access procedure on carrier 2 directly. To facilitate this type of functionality, the UE 110 may receive certain types of system information for carrier 2 prior to the initial access procedure. In some embodiments, the UE 110 may perform measurements and synchronization operations on carrier 2 directly before initial access. In other embodiments, the UE 110 may rely on carrier 1 for measurement and/or synchronization on carrier 2. After receiving a paging message, whether the UE performs initial access on carrier 1 or carrier 2 may be determined autonomously by the UE. For example, the network may inform the UE of multiple available carriers via broadcast signaling. Alternatively, after receiving a paging message, whether the UE performs the initial access on carrier 1 or carrier 2 may be at least partially controlled by the network. For example, the network may indicate that there are two carriers available and then the UE determines which carrier to use for initial access. In some examples, the UE may use a predefined function (e.g., hashing function, etc.) to select a carrier for initiation access that depends on the UE ID, a cell ID and/or any other appropriate parameter provided by the network.

The examples described above with regard to scenarios 400 and 450 are not intended to limit the exemplary embodiments in any way. Instead, the scenarios 400 and 450 are provided as general non-limiting examples related to cross-carrier SIB transmission. The exemplary embodiments introduce techniques for system information modification to support the implementation of cross-carrier SIB transmission performed in any appropriate manner.

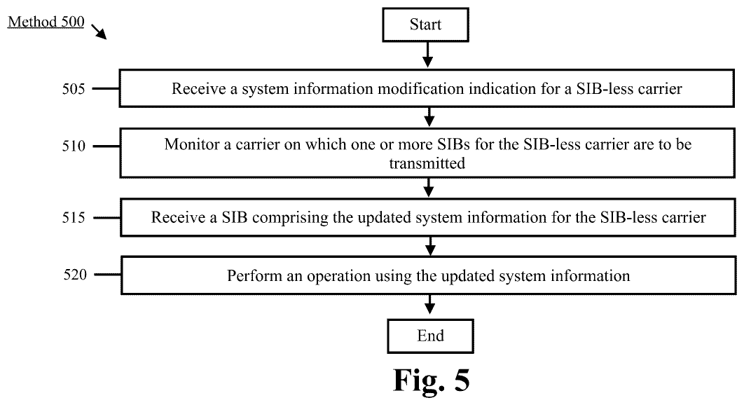

FIG. 5 shows a method 500 for system information modification according to various exemplary embodiments. The method 500 is described from the perspective of the UE 110 of the network arrangement 100 of FIG. 1.

Initially, assume a scenario in which the UE 110 is deployed within the vicinity of multiple cells operated by the gNB 120A. A first cell of the gNB 120A may operate on a first carrier (e.g., carrier 1) and a second cell of the gNB 120A may operate on a second carrier (e.g., carrier 2). For any of a variety of different reasons, the gNB 120A may be triggered to utilize cross-carrier SIB transmission where one or more types of SIBs for carrier 2 are to be transmitted on carrier 1.

In 505, the UE 110 receives a system information modification indication for a SIB-less carrier (e.g., carrier 2). In some embodiments, the system information modification indication may be provided to the UE 110 in paging DCI transmitted on carrier 1. In other embodiments, the system information modification indication may be provided to the UE 110 in paging DCI transmitted on carrier 2. In further embodiments, the system information modification indication may be provided to the UE 110 in a light signal transmitted on the SIB-less carrier. Accordingly, the system information modification information indication for the SIB-less carrier may be received on the SIB-less carrier or on another carrier. Each of these exemplary embodiments will be discussed in more detail below after the method 500.

In 510, the UE 110 monitors a carrier on which one or more SIBs for the SIB-less carrier are to be transmitted. In this example, the UE 110 is configured to monitor carrier 1 to receive one or more types of SIBs for carrier 2. In 515, the UE 110 receives a SIB comprising the updated system information for the SIB-less carrier.

In some embodiments, a system information modification period may be utilized to receive the SIB comprising the updated system information for the SIB-less carrier. Those skilled in the art will understand that the modification period approach may comprise a first modification period during which the system information modification indication may be transmitted one or more times (e.g., 505) and a second subsequent modification period during which the updated system information is to be transmitted one or more times. Thus, the UE 110 may receive the system modification indication during one modification period and expect to decode one or more SIBs comprising the updated system information during a next modification period.

In other embodiments, the UE 110 may start to receive the SIBs for the SIB-less carrier after the UE 110 receives the system information modification indication instead of waiting for a modification period to end or any other similar type of mechanism. For example, once the gNB 120A transmits the system information modification indication in one or more time locations, the gNB 120A starts to transmit the SIBs for the SIB-less carrier without waiting for a boundary of a modification period. However, the gNB 120A may or may not implement a delay in between transmitting the system information modification indication and transmitting the one or more SIBs comprising the updated system information to account for processing time at the UE 110. In some embodiments, the gNB 120A may transmit all of the one or more types of SIBs for the SIB-less carrier within a preconfigured time window after transmitting a single system information modification indication to avoid a scenario in which the UE 110 monitors for SIBs indefinitely or for an unnecessary long time.

In 520, the UE 110 performs an operation using the updated system information. To provide one example, the UE 110 may attempt initial access on carrier 2 using the updated system information received on carrier 2. However, the manner in which the updated system information is used by the UE 110 is beyond the scope of the exemplary embodiments. The exemplary embodiments introduce techniques related to providing up-to-date system information for a SIB-less carrier that may be used by the UE 110 for any appropriate operation (if at all).

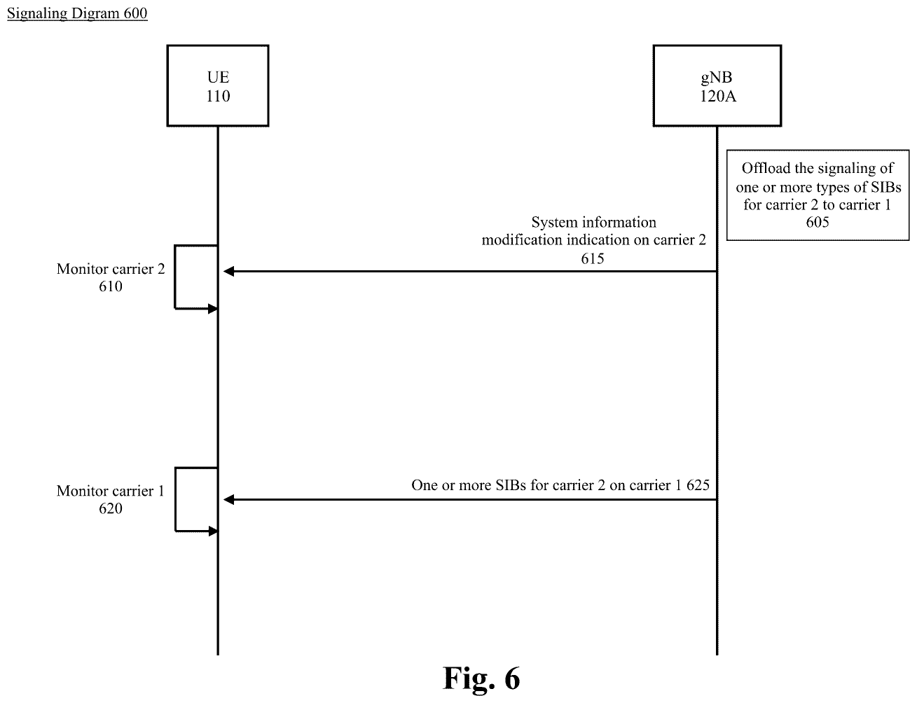

As mentioned above in 505 of the method 500, in some embodiments, the system information modification indication may be provided to the UE 110 in paging DCI. FIG. 6 shows a signaling diagram 600 for system information modification indication for a SIB-less carrier being transmitted on the SIB-less carrier according to various exemplary embodiments. The signaling diagram 600 includes the UE 110 and the gNB 120A of the network arrangement 100 of FIG. 1.

In 605, the gNB 120A offloads the signaling of one or more types of SIBs for carrier 2 to carrier 1. For example, a condition or event occurs which triggers the gNB 120A to utilize cross-carrier SIB transmission. However, the manner in which the gNB 120A is triggered to utilize cross-carrier SIB transmission is beyond the scope of exemplary embodiments. Instead, the exemplary embodiments introduce techniques for signaling a system information modification indication to support the implementation of cross-carrier SIB transmission.

In 610, the UE 110 monitors carrier 2 (e.g., the SIB-less carrier) during one or more monitoring occasions. For example, the UE 110 may be configured to monitor carrier 2 for downlink control signaling during a monitoring occasion. In another example, the UE 110 may be configured to monitor carrier 2 for system information, reference signals and/or discovery signals during a monitoring occasion.

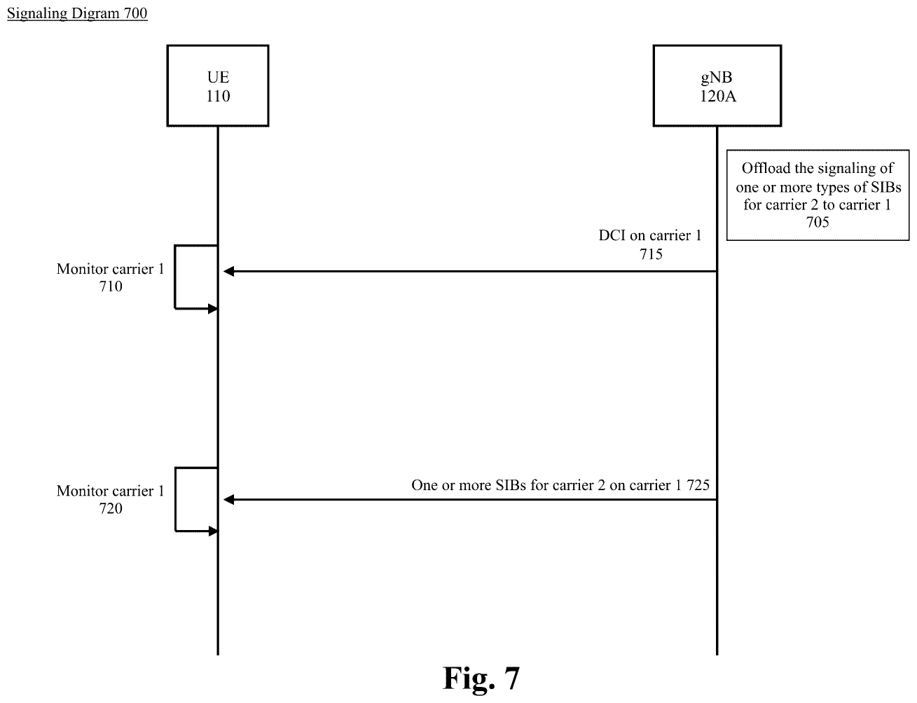

In 615, the gNB 120A transmits the system information modification indication to the UE 110 on carrier 2. The system information modification indication may be provided via DCI. In some embodiments, the system information modification indication may be provided reusing an existing system information modification indication field in paging DCI. In some embodiments, a short message provided over DCI may be enhanced to include the system information modification indication. Additional details for a short message enhanced to include a system information modification indication for a SIB-less carrier are provided below with regard to the signaling diagram 700 of FIG. 7.

The system information modification indication may be provided via a discovery signal or a reference signal that is transmitted on the SIB-less carrier. When utilizing this approach, the system information modification indication may be configured as a single bit to minimize signaling on the SIB-less carrier. However, the exemplary embodiments are not limited to a single bit and the system information modification indication may be any appropriate size. In some embodiments, the discovery signal or reference signal may be arranged in a particular sequence or pattern that is associated with a system information modification indication. For example, a reference signal or discovery signal arranged in a first pattern in the frequency and/or time domain may imply a system information modification indication. When the reference signal or discovery signal is arranged in a second different pattern in the frequency and/or time domain, this may not imply a system information modification indication.

The system information modification information may be provided using system information that is transmitted on the SIB-less carrier. The system information may comprise one or more bits for the system modification indication. When using this approach, compared to legacy SIB messages, the network may limit the size, periodicity and/or frequency with which the gNB 120A transmits system information to enable the gNB 120A to achieve network power saving.

In 620, the UE 110 monitors for one or more types of SIBs for carrier 2 on carrier 1. Thus, in response to the system information modification indication received on carrier 2 the UE 110 may tune its transceiver 225 from carrier 2 to carrier 1. For example, the system information transmitted on carrier 2 may further include information that notifies the UE 110 when and where the one or more SIBs for carrier 2 are to be transmitted on carrier 1. However, this example is merely provided for illustrative purposes. The UE 110 may blindly search carrier 1 and/or utilize any appropriate type of information provided to the UE 110 in any appropriate manner to monitor carrier 1 for the one or more SIBs of carrier 2.

In 625, the gNB 120A transmits the one or more SIBs to the UE 110 on carrier 1. The one or more SIBs comprising the updated system information for carrier 2, e.g., the SIB-less carrier.

FIG. 7 shows a signaling diagram 700 for system information modification indication for a SIB-less carrier being transmitted on another carrier via paging DCI according to various exemplary embodiments. The signaling diagram 700 includes the UE 110 and the gNB 120A of the network arrangement 100 of FIG. 1.

In 705, the gNB 120A offloads the signaling of one or more types of SIBs for carrier 2 to carrier 1. For example, a condition or event occurs which triggers the gNB 120A to utilize cross-carrier SIB transmission. However, the manner in which the gNB 120A is triggered to utilize cross-carrier SIB transmission is beyond the scope of exemplary embodiments. Instead, the exemplary embodiments introduce techniques for signaling a system information modification indication to support the implementation of cross-carrier SIB transmission.

In 710, the UE 110 monitors for paging DCI on carrier 1. For example, the UE 110 may be configured to monitor carrier 1 for downlink control signaling during a monitoring occasion. In 715, the gNB 120A transmits the paging DCI comprising the system information modification indication of carrier 2 to the UE 110 on carrier 1.

According to some aspects, a short message may be enhanced to provide the system information modification indication for the SIB-less carrier. Those skilled in the art will understand that the short message may be transmitted via DCI during a paging occasion/PDCCH monitoring occasion for paging.

One or more bits of the short message may be used to indicate the system information modification indication for one or more SIB-less carriers. Those skilled in the art will understand that the short message referenced herein is defined in various 3GPP specifications. In this description, the short message may be used in accordance with the manner in which it is defined in the 3GPP specification and the exemplary embodiments described herein. For instance, the short message may be currently defined to comprise multiple reserved bits. The exemplary embodiments may utilize these currently reserved bits for the system information modification indication for a SIB-less carrier and not change the defined size of the short message. In other examples, the size of the short message may be changed to accommodate the system information modification indication. While these exemplary aspects are described with regard to the signaling diagram 700, the exemplary aspects of the short message introduced herein may be used regardless of whether the system information modification is transmitted on the SIB-less carrier (e.g., signaling diagram 600) or another carrier. However, in some embodiments, when the UE 110 monitors for paging DCI on the SIB-less carrier, a system information modification indication only for the SIB-less carrier may be provided.

Each SIB-less carrier may utilize one or more bits of the short message. The exemplary embodiments introduce a 1-bit “systemInfoModification-crossCarrier” parameter for the short message configured to indicate a system information modification other than SIB6/SIB7/SIB8 for non-extended discontinuous reception (eDRX) UEs. In addition, the exemplary embodiments introduce a 1-bit “systemInfoModification-eDRX-crossCarrier” parameter for the short message configured to indicate a system information modification other than SIB6/SIB7/SIB8 for eDRX UEs. In another example, the exemplary embodiments introduce a 1-bit “systemInfoModification-crossCarrier” parameter for the short message configured to indicate a system information modification other than SIB6/SIB7/SIB8 for non-eDRX and eDRX UEs. Further, the exemplary embodiments introduce a 1-bit “etwsAndCmasIndication-crossCarrier” parameter for the short message configured to indicate an earthquake and tsunami warning system (ETWS) primary notification and/or an ETWS secondary notification and/or a commercial mobile alert service (CMAS) notification for the SIB-less carrier. However, reference to “systemInfoModification-crossCarrier,” “systemInfoModification-eDRX-crossCarrier,” “systemInfoModification-crossCarrier” and “etwsAndCmasIndication-crossCarrier” is merely provided for illustrative purposes. Different entities may refer to similar concepts by different names.

In some embodiments, the network may configure an existing SIB or introduce a new SIB to indicate to the UE 110 which bits of the short message are to be used for a SIB-less carrier. For scenarios comprising multiple SIB-less carriers, separate bits may be used. The mapping between the bits and the carriers may be configured by an existing SIB or introduce a new SIB to indicate to the UE 110 which bits of the short message are to be used for which SIB-less carrier. However, the exemplary embodiments are not required to provide this type of information via a SIB. The exemplary embodiments apply to this type of information being explicitly or implicitly provided to the UE 110 in any appropriate manner.

According to some aspects, DCI format 1_0 scrambled with a paging radio network temporary identifier (RNTI) (e.g., paging DCI) may be enhanced to provide the system information modification indication for the SIB-less carrier. Those skilled in the art will understand that DCI format 1_0 may be transmitted during a PDCCH monitoring occasion for paging. Some of the bits of DCI format 1_0 may be used for short messages. In addition, there are various reserved bits.

In this description, the paging DCI format 1_0 may be used in accordance with the manner in which it is defined in the 3GPP specification and the exemplary embodiments described herein. For instance, the DCI format 1_0 may be currently defined to comprise multiple reserved bits. The exemplary embodiments may utilize these currently reserved bits for the system information modification indication for a SIB-less carrier and not change the defined size of the DCI format 1_0. In other examples, the size of DCI format 1_0 may be changed to accommodate the system information modification indication, a new DCI may be introduced for this purpose or another already defined DCI format may be enhanced to include the system information modification for the SIB-less carrier. While these exemplary aspects are described with regard to the signaling diagram 700, the exemplary aspects of paging DCI introduced herein may be used regardless of whether the system information modification is transmitted on the SIB-less carrier (e.g., signaling diagram 600) or another carrier.

While these exemplary aspects are described with regard to the signaling diagram 700 comprising transmitting the system information modification indication for the SIB-less carrier on another SIB, this exemplary short message may be used regardless of whether the system information modification is transmitted on the SIB-less carrier (e.g., signaling diagram 600) or another carrier.

In 720, the UE 110 monitors for one or more types of SIBs for carrier 2 on carrier 1. For example, the network may notify the UE 110 when and where the one or more SIBs for carrier 2 are to be transmitted on carrier 1. In other examples, the UE 110 may blindly search carrier 1 and/or utilize any appropriate type of information provided to the UE 110 in any appropriate manner to monitor carrier 1 for the one or more SIBs of carrier 2.

In 725, the gNB 120A transmits the one or more SIBs to the UE 110 on carrier 1. The one or more SIBs comprising the updated system information for carrier 2, e.g., the SIB-less carrier.

### EXAMPLES

In a first example, a method is performed by a user equipment (UE), comprising receiving a system information modification indication monitoring a first carrier for one or more types of system information blocks (SIBs) of a second carrier in response to the system information modification indication, wherein the second carrier is configured with cross-carrier SIB transmission on the first carrier for the one or more types of SIBs and receiving a SIB for the second carrier on the first carrier.

In a second example, the method of the first example, wherein the system information modification indication is provided in paging downlink control information (DCI).

In a third example, the method of the second example, wherein the paging DCI is transmitted on the second carrier.

In a fourth example, the method of the second example, wherein the paging DCI is transmitted on the first carrier.

In a fifth example, the method of the second example, wherein the system information modification indication is provided in a short message of the paging DCI.

In a sixth example, the method of the fifth example, wherein the short message comprises a 1-bit parameter configured to indicate a system information modification for non-extended discontinuous reception (eDRX) UEs.

In a seventh example, the method of the fifth example, wherein the short message comprises a 1-bit parameter configured to indicate a system information modification for extended discontinuous reception (eDRX) UEs.

In an eighth example, the method of the fifth example, wherein the short message comprises a 1-bit parameter configured to indicate a system information modification for extended discontinuous reception (eDRX) UEs and non-eDRX UEs.

In a ninth example, the method of the fifth example, wherein the second carrier is one of multiple carriers configured with cross-carrier SIB transmission on the first carrier for the one or more types of SIBs, and wherein the short message comprises multiple sets of one or more bits, each set of one or more bits mapped to a respective one of the multiple carriers.

In a tenth example, the method of the first example, wherein the system information modification indication is explicitly provided as one or more bits of a paging downlink control information (DCI) message.

In an eleventh example, the method of the first example, wherein the system information modification indication is provided in a discovery signal transmitted on the second carrier.

In a twelfth example, the method of the eleventh example, wherein the discovery signal is arranged in a predefined sequence or pattern to indicate the system information modification indication is associated with the discovery signal.

In a thirteenth example, the method of the first example, wherein the system information modification indication is provided in a reference signal transmitted on the second carrier.

In a fourteenth example, the method of the thirteenth example, wherein the reference signal is arranged in a predefined sequence or pattern to indicate the system information modification indication is associated with the reference signal.

In a fifteenth example, the method of the first example, wherein the system information modification indication is provided in a common message transmitted on the second carrier.

In a sixteenth example, the method of the first example, wherein the system information modification indication is transmitted during a modification period on the first carrier.

In a seventeenth example, the method of the first example, wherein the system information modification indication is transmitted during a modification period on the second carrier.

In an eighteenth example, the method of the first example, further comprising receiving all of the one or more types of SIBs within a predetermined time window that occurs after the reception of the system information modification indication.

In a nineteenth example, a processor configured to perform any of the methods of the first through eighteenth examples.

In a twentieth example, a user equipment (UE) comprising a transceiver configured to communicate with a network and a processor communicatively coupled to the transceiver and configured to perform any of the methods of the first through eighteenth examples.

In a twenty first example, a method is performed by a base station, comprising transmitting a system information modification indication to a user equipment (UE), wherein the base station deploys at least a first carrier and a second carrier and wherein the second carrier is configured with cross-carrier system information block (SIB) transmission on the first carrier for one or more types of SIBs and transmitting a SIB for the second carrier on the first carrier.

In an twenty second example, the method of the twenty first example, wherein the system information modification indication is provided in paging downlink control information (DCI).

In an twenty third example, the method of the twenty second example, wherein the paging DCI is transmitted on the second carrier.

In an twenty fourth example, the method of the twenty second example, wherein the paging DCI is transmitted on the first carrier.

In an twenty fifth example, the method of the twenty second example, wherein the system information modification indication is provided in a short message of the paging DCI.

In an twenty sixth example, the method of the twenty fifth example, wherein the short message comprises a 1-bit parameter configured to indicate a system information modification for non-extended discontinuous reception (eDRX) UEs.

In an twenty seventh example, the method of the twenty fifth example, wherein the short message comprises a 1-bit parameter configured to indicate a system information modification for extended discontinuous reception (eDRX) UEs.

In an twenty eighth example, the method of the twenty fifth example, wherein the short message comprises a 1-bit parameter configured to indicate a system information modification for extended discontinuous reception (eDRX) UEs and non-eDRX UEs.

In an twenty ninth example, the method of the twenty fifth example, wherein the second carrier is one of multiple carriers configured with cross-carrier SIB transmission on the first carrier for the one or more types of SIBs, and wherein the short message comprises multiple sets of one or more bits, each set of one or more bits mapped to a respective one of the multiple carriers.

In an thirtieth example, the method of the twenty first example, wherein the system information modification indication is explicitly provided as one or more bits of a paging downlink control information (DCI) message.

In an thirty first example, the method of the twenty first example, wherein the system information modification indication is provided in a discovery signal transmitted on the second carrier.

In an thirty second example, the method of the thirty first example, wherein the discovery signal is arranged in a predefined sequence or pattern to indicate the system information modification indication is associated with the discovery signal.

In an thirty third example, the method of the twenty first example, wherein the system information modification indication is provided in a reference signal transmitted on the second carrier.

In an thirty fourth example, the method of the thirty third example, wherein the reference signal is arranged in a predefined sequence or pattern to indicate the system information modification indication is associated with the reference signal.

In an thirty fifth example, the method of the twenty first example, wherein the system information modification indication is provided in a common message transmitted on the second carrier.

In an thirty sixth example, the method of the twenty first example, wherein the system information modification indication is transmitted during a modification period on the first carrier.

In an thirty seventh example, the method of the twenty first example, wherein the system information modification indication is transmitted during a modification period on the second carrier.

In an thirty eighth example, the method of the twenty first example, further comprising transmitting all of the one or more types of SIBs within a predetermined time window that occurs after the system information modification indication.

In a thirty ninth example, a processor configured to perform any of the methods of the twenty first through thirty eighth examples.

In fortieth example, a base station comprising a transceiver configured to communicate with a user equipment (UE) and a processor communicatively coupled to the transceiver and configured to perform any of the methods of the twenty first through thirty eighth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signaling received from a base station, a system information modification indication;
monitor a first carrier for one or more types of system information blocks (SIBs) of a second carrier in response to the system information modification indication, wherein the second carrier is configured with cross-carrier SIB transmission on the first carrier for the one or more types of SIBs; and
decode, based on signaling received from the base station a SIB for the second carrier on the first carrier.

2. The apparatus of claim 1, wherein the system information modification indication is provided in paging downlink control information (DCI).

3. The apparatus of claim 2, wherein the paging DCI is transmitted on the second carrier.

4. The apparatus of claim 2, wherein the paging DCI is transmitted on the first carrier.

5. The apparatus of claim 2, wherein the system information modification indication is provided in a short message of the paging DCI.

6. The apparatus of claim 5, wherein the short message comprises a 1-bit parameter configured to indicate a system information modification for non-extended discontinuous reception (eDRX) UEs.

7. The apparatus of claim 5, wherein the short message comprises a 1-bit parameter configured to indicate a system information modification for extended discontinuous reception (eDRX) UEs.

8. The apparatus of claim 5, wherein the short message comprises a 1-bit parameter configured to indicate a system information modification for extended discontinuous reception (eDRX) UEs and non-eDRX UEs.

9. The apparatus of claim 5, wherein the second carrier is one of multiple carriers configured with cross-carrier SIB transmission on the first carrier for the one or more types of SIBs, and
wherein the short message comprises multiple sets of one or more bits, each set of one or more bits mapped to a respective one of the multiple carriers.

10. The apparatus of claim 1, wherein the system information modification indication is explicitly provided as one or more bits of a paging downlink control information (DCI) message.

11. The apparatus of claim 1, wherein the system information modification indication is provided in a discovery signal transmitted on the second carrier.

12. The apparatus of claim 11, wherein the discovery signal is arranged in a predefined sequence or pattern to indicate the system information modification indication is associated with the discovery signal.

13. The apparatus of claim 1, wherein the system information modification indication is provided in a reference signal transmitted on the second carrier.

14. The apparatus of claim 13, wherein the reference signal is arranged in a predefined sequence or pattern to indicate the system information modification indication is associated with the reference signal.

15. The apparatus of claim 1, wherein the system information modification indication is provided in a common message transmitted on the second carrier.

16. The apparatus of claim 1, wherein the system information modification indication is transmitted during a modification period on the first carrier.

17. The apparatus of claim 1, wherein the system information modification indication is transmitted during a modification period on the second carrier.

18. The apparatus of claim 1, wherein the processing circuitry is further configured to:
decode, based on signaling received from the base station, all of the one or more types of SIBs within a predetermined time window that occurs after the reception of the system information modification indication.

19. An apparatus of a base station, the apparatus comprising processing circuitry configured to:
configure transceiver circuitry to transmit a system information modification indication to a user equipment (UE), wherein the base station deploys at least a first carrier and a second carrier and wherein the second carrier is configured with cross-carrier system information block (SIB) transmission on the first carrier for one or more types of SIBs; and
configure transceiver circuitry to transmit a SIB for the second carrier on the first carrier.

20. The apparatus of claim 19, wherein the system information modification indication is provided in paging downlink control information (DCI).
